(19) United States
(12) Patent Application Publication
(10) Pub. No.: US 2024/0054427 A1
(43) Pub. Date: Feb. 15, 2024

(54) AN INSTRUMENT SCRAP EVALUATION METHOD BASED ON CLOUD PLATFORM BIG DATA MANAGEMENT

(71) Applicant: Hainan Master Ma Liang Internet Technology Co., Ltd, Hainan (CN)

(72) Inventors: Ping ZHANG, Hainan (CN); Ting ZHANG, Hainan (CN); Aobo ZHANG, Hainan (CN)

(21) Appl. No.: 17/598,461

(22) PCT Filed: Sep. 2, 2021
(86) PCT No.: PCT/CN2021/116088

§ 371 Date: Sep. 27, 2021

(30) Foreign Application Priority Data
Jul. 14, 2021 (CN) 202110796144.2

(51) Int. Cl. G06Q 10/0639; G06Q 10/20

(52) U.S. Cl. CPC G06Q 10/06393; G06Q 10/20

(57) ABSTRACT

The invention provides an instrument scrap evaluation method based on cloud platform big data management, which belongs to the field of information management. The evaluation method uses cloud platform to download, store, integrate and modify the benchmark operating state data, store the current vital data, current operating data and current operating state data of the instrument. Using operation evaluation subsystem of current life data, the current running data with reference data and the benchmark run corresponding comparative analysis of the data made for current running status data, then compared with the running state of the benchmark data analysis, get the evaluation results, and output the corresponding alarm, operations staff to alarm apparatus for artificial judgment.

### FIELD OF THE INVENTION

The invention relates to instrument management, in particular to an instrument scrap evaluation method based on cloud platform big data management.

### BACKGROUND OF THE INVENTION

With the integration of production and management, there are many problems in the use and management of instruments and equipment in laboratories or enterprises. Some lost purchase and installation information in the process of use, resulting in the inability to know the original parameters of the instrument/equipment; Some in the use of the process, due to the failure of the instrument/equipment leading to measurement data deviation, can not be found in time, leading to experimental personnel to judge the experimental results of error; Some in the use process, the instrument reached the scrap standard, can not be timely informed, resulting in continued maintenance and waste of resources. In the existing technology, the management of instruments/equipment in laboratories or enterprises is mainly carried out by manual registration, and it is impossible to timely know whether the instruments/equipment needs to be repaired or scrapped.

### SUMMARY OF THE INVENTION

To solve the above problems, the invention provides an instrument scrapping evaluation method based on cloud platform big data management.

To achieve the above purposes, the technical scheme of the invention is as follows:

The instrument scrapping evaluation method based on cloud platform big data management,

The evaluation method is to use the instrument scrap evaluation system based on cloud platform big data management to evaluate the instruments in the region; the instrument scrap evaluation system based on cloud platform big data management includes: traceability subsystem, operation monitoring subsystem, operation evaluation subsystem and cloud platform;

the traceability subsystem connects the instrument and the cloud platform, which is used to obtain the current life data of the instrument from testing, use, maintenance to scrapping, and store the current life data to the cloud platform;

operation the monitoring subsystem, connect the instrument and the cloud platform, for monitoring the operating status of the instrument, obtain the current operating data of the instrument, and store it to the cloud platform;

cloud platform, regularly download and store the officially published benchmark life data, benchmark operation data and benchmark operation status data, and make real-time corrections; by connecting the traceability subsystem, operation monitoring subsystem and operation evaluation subsystem, the current life data, current operation data and current operation status data of the instrument are stored; periodically classify and sort out the current life data and current operation data, revise the benchmark life data, benchmark operation data and benchmark operation state data in real time, and get the corresponding benchmark operation state data when the instrument is lost/scrapped;

the evaluation subsystem is operated and connected to the cloud platform, which is used to evaluate the current life data and current operating data, analyze the current operating status data, and store it to the cloud platform; then the current operating status data is compared and analyzed with the benchmark operating status data, and the evaluation results of maintenance/scrap or normal operation are given according to the comparison results.

And further, instrument scrap evaluation system based on cloud platform big data management further comprising the query retrieval subsystem; the query retrieval subsystem is connected to the cloud platform to query the instrument's current life data, current operating data, current operating status data, benchmark life data, benchmark operating data and benchmark operating status data, and to track and trace the instrument.

And further, the query retrieval subsystem has computer query retrieval interface, intelligent terminal query retrieval interface and telephone voice query retrieval interface, which are respectively connected to the cloud platform information through the operation evaluation subsystem.

And further, the traceability subsystem includes the instrument detection management module, installation and use management module and maintenance/scrap management module, which are respectively connected with the cloud platform information.

And further, operation evaluation subsystem includes component evaluation module, whole evaluation module, alarm module and query retrieval module; the above modules are respectively connected with the cloud platform information; among them, the component evaluation module is also connected to the overall evaluation module with one-way information; the overall evaluation module is connected with the alarm module information; query retrieval module and query retrieval subsystem information connection.

And further, the overall evaluation module evaluates the instrument according to the evaluation results of the component evaluation module to determine the operating status of the instrument.

And further, the evaluation methods includes the following steps:

the cloud platform regularly downloads and stores the officially published benchmark life data, benchmark operation data and benchmark operation state data, integrates and analyzes the benchmark operation state data when the instrument is worn or scrapped, and makes real-time corrections;

through the traceability subsystem, the current life data of the instrument is obtained, and the current life data is transferred to the cloud platform for storage;

when the instrument is running, it can track the operation and status of the instrument in real time by running the monitoring subsystem, obtain the current operation data of the instrument, and transfer the current operation data to the cloud platform for storage;

operation evaluation subsystem, which obtains benchmark life data, benchmark operation data and benchmark operation state data from the cloud platform;

the current life data and current operating data are compared and analyzed with the benchmark life data and the benchmark operating data respectively to obtain the current operating status data;

again when the cloud platform for instrument/scrap loss corresponding benchmark running status data, and compared with the current running status data analysis, get the instrument need to repair/scrap or normal operation of the evaluation results, and output the corresponding alarm, operations staff to alert again said to repair/scrap instruments for artificial judgment, And artificial judgment result to feedback to operation evaluation subsystem, get the failure datum running status data, the failure datum life data and the failure datum operation data, the data retransmission to cloud storage platform, through life with artificial judgment before the benchmark data respectively, benchmark data operation and the running state of the benchmark data integration, form the benchmark operation state data, benchmark life data and benchmark operation data for next use.

And further, the evaluation method also includes inputting the information to be queried in the query retrieval subsystem, and directionally querying the instrument's current life data, current operating data, current operating state data, benchmark life data, benchmark operating data and benchmark operating state data through the operation of the evaluation subsystem.

The beneficial effects of the invention are as follows:

This invention by designing a set of laboratory instrument/equipment/enterprise for real-time tracking management of big data management based on the cloud platform instrument scrap assessment system, constructing the instrument/equipment scrapped evaluation model, using the assessment system in a timely manner from the network for instrument during the operation of the instrument and related data, judging whether you need for instrument maintenance/scrap, Notify operation personnel, operation personnel on-the-spot investigation confirmed scrap need abandoned instruments, and through the artificial judgment result to feedback to the cloud platform, to targeted correction instrument related data, in order to provide more accurate scrap index reference, thus more accurate assessment of the true state of instrument/equipment, instrument/equipment failure in time, to scrap processing, Reduce unnecessary maintenance resources waste, reduce the error of experimental results;

The evaluation system of the invention can also consult the data of any instrument at any time to know the state of the instrument.

### BRIEF DESCRIPTION OF DRAWINGS

FIG. 1 is a schematic diagram of instrument scrap evaluation system based on cloud platform big data management in an embodiment of the invention.

### DETAILED DESCRIPTION OF EXEMPLARY EMBODIMENTS

The following is a clear and complete description of the technical scheme in an embodiment of the invention. In the following description describes the many details in order to fully understand the present invention, but the present invention can also use other different from the description of other ways to commit to the field technicians can do in the case of violation of the present invention is similar, therefore the present invention is not restricted by public under the concrete implementation example.

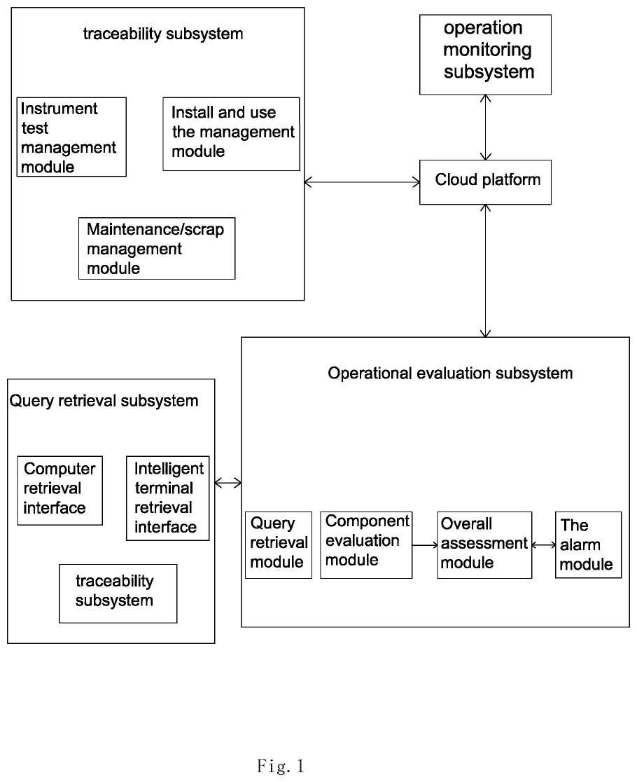

As shown in FIG. 1, this example is a kind of big data management based on the cloud platform instrument scrap evaluation methods, is the use of big data management based on the cloud platform of instrument scrap assessment system, described based on the cloud platform big data management instruments scrap evaluation system includes: tracing subsystem, running monitoring subsystem, evaluation subsystem, cloud platform and query retrieval subsystem.

The traceability subsystem connects the instrument and the cloud platform, which is used to obtain the life data of the instrument from testing, use, maintenance to scrapping, and store the life data to the cloud platform; The traceability subsystem includes the detection management module, installation and use management module and maintenance/scrap management module of the instrument. The above modules are connected with the cloud platform information respectively. Through different management modules, the current life data of the instrument in different periods are obtained and transmitted to the cloud platform for subsequent judgment. The instrument detection management module is used to detect all kinds of factory Settings and parameters of the collection instrument, such as the detection and collection wavelength range, wavelength accuracy, stray light parameters in the ultraviolet spectrophotometer; Install and use the management module, used to detect the installation location, user information, etc. Maintenance/scrap management module is used to detect all kinds of parameters in the process of using the instrument, such as the collection wavelength range, wavelength accuracy and stray light parameters of the ULTRAVIOLET spectrophotometer after using for a period of time.

Run the monitoring subsystem, connect the instrument and the cloud platform, monitor the operating status of the instrument, obtain the operating data of the instrument, and store it to the cloud platform.

Cloud platform, regularly download and store the officially published benchmark life data, benchmark operation data and benchmark operation status data, and make real-time corrections; By connecting the traceability subsystem, monitoring subsystem and operation evaluation subsystem, the current vital data and current operation data of the instrument are stored; Periodically classify and sort the current life data, current operating data and current operating status data, revise the benchmark life data, benchmark operating data and benchmark operating status data in real time, and obtain the corresponding operating status data when the instrument is lost/scrapped.

The evaluation subsystem is operated and connected to the cloud platform, which is used to evaluate the current life data and current operating data, analyze and obtain the current operating status data of the instrument, and store it to the cloud platform; Then compare and analyze the current operating status data with the benchmark operating status data, and give the evaluation results of to maintenance/scrap or normal operation according to the comparison results; Operation evaluation subsystem includes component evaluation module, whole evaluation module, alarm module and query retrieval module. The above modules are connected with cloud platform information respectively. The component evaluation module is also connected to the overall evaluation module with one-way information, that is to complete the information transmission from the component evaluation module to the overall evaluation module. The overall evaluation module is connected with the alarm module information; Query retrieval module and query retrieval subsystem information connection; Through these one-way or two-way information connections, information is transmitted. Component evaluation module, used to evaluate component level evaluation, component evaluation includes current transformer, voltage transformer, secondary loop, etc.; The current operating data and evaluation results obtained by the component evaluation module are transmitted to the cloud platform and the overall evaluation module respectively. Overall assessment module, including total acquisition instrument to evaluate various parameters, such as collection of ultraviolet spectrophotometer wavelength range, wavelength accuracy, stray light, and a series of parameters for the overall evaluation, and based on the current running data of component evaluation module, an overall evaluation of the instrument and the evaluation result, finally determine the current operation state data. After the overall evaluation module makes a judgment, it simultaneously transmits the current operating status data and judgment results to the cloud platform, and sends the judgment results (i.e., the information of the instrument in need of maintenance/scrapping) to the alarm module to issue the corresponding alarm; The alarm module can also feed back the result of manual judgment made by operation and maintenance personnel to the overall evaluation module and upload it to the cloud platform.

Query retrieval subsystem connected to the cloud platform, used to query the instrument's life data, operating data and operating status data, and to track and trace the instrument; The query and retrieval subsystem has computer query and retrieval interface, intelligent terminal query and retrieval interface and telephone voice query and retrieval interface. Through each query and retrieval interface, the query and retrieval module in the operation evaluation subsystem can retrieve the data information on the cloud platform and query the real-time status of the instrument.

In this embodiment, the instrument scrap evaluation method based on cloud platform big data management includes the following steps:

The cloud platform regularly downloads and stores the officially published benchmark life data, benchmark operation data and benchmark operation state data, integrates and analyzes the benchmark operation state data when the instrument is worn or scrapped, and makes real-time corrections;

Through the traceability subsystem, obtain the instrument's life data, and transfer the current life data to the cloud platform for storage;

When the instrument is running, it can track the operation and status of the instrument in real time by running the monitoring subsystem, obtain the current operation data of the instrument, and transfer the current operation data to the cloud platform for storage.

The operation evaluation subsystem obtains benchmark life data, benchmark operating data and benchmark operating status data from the cloud platform, and compares and analyzes the current life data and current operating data with the benchmark life data and benchmark operating data respectively to obtain the current operating status data;

Again when the cloud platform for instrument/scrap loss corresponding benchmark running status data, and compared with the current running status data analysis, get the instrument need to repair/scrap or normal operation of the evaluation results, and output the corresponding alarm, operations staff to alert again said to repair/scrap instruments for artificial judgment, And artificial judgment result to feedback to operation evaluation subsystem, get the failure datum running status data, the failure datum life data and the failure datum operation data, the data retransmission to cloud storage platform, through life with artificial judgment before the benchmark data respectively, benchmark data operation and the running state of the benchmark data integration, Form the benchmark operation state data, benchmark life data and benchmark operation data for next use.

Meanwhile, the evaluation method can also input the information to be queried into the query retrieval subsystem, and retrieve the data information on the cloud platform by running the query retrieval module in the evaluation subsystem. The current life of directional query instrument data, the current running data, the current running status data, baseline data, data and the benchmark run benchmark life running status data (including current life data, the current running data, the current running status data, baseline data, data and the benchmark run benchmark life running status data also includes the history of the current life, history and the current operation Data, historical current health data, historical baseline health data, historical baseline health data, and historical baseline health data).

Obviously, the described embodiments are only partial embodiments of the invention and not all embodiments. Based on the embodiments of the invention, all other embodiments obtained by ordinary technical personnel in the field without making creative labor belong to the scope of the invention protection.

1. An instrument scrap evaluation method based on cloud platform big data management,
the evaluation method is to use the instrument scrap evaluation system based on cloud platform big data management to evaluate the instruments in the region; the instrument scrap evaluation system based on cloud platform big data management includes: traceability subsystem, operation monitoring subsystem, operation evaluation subsystem and cloud platform;
the traceability subsystem connects the instrument and the cloud platform, which is used to obtain the current life data of the instrument from testing, use, maintenance to scrapping, and store the current life data to the cloud platform;
operation the monitoring subsystem, connect the instrument and the cloud platform, for monitoring the operating status of the instrument, obtain the current operating data of the instrument, and store it to the cloud platform;
cloud platform, regularly download and store the officially published benchmark life data, benchmark operation data and benchmark operation status data, and make real-time corrections; by connecting the traceability subsystem, operation monitoring subsystem and operation evaluation subsystem, the current life data, current operation data and current operation status data of the instrument are stored; periodically classify and sort out the current life data and current operation data, revise the benchmark life data, benchmark operation data and benchmark operation state data in real time, and get the corresponding benchmark operation state data when the instrument is lost/scrapped;
the evaluation subsystem is operated and connected to the cloud platform, which is used to evaluate the current life data and current operating data, analyze the current operating status data, and store it to the cloud platform; then the current operating status data is compared and analyzed with the benchmark operating status data, and the evaluation results of maintenance/scrap or normal operation are given according to the comparison results.

2. The instrument scrapping evaluation method according to claim 1, instrument scrap evaluation system based on cloud platform big data management further comprising the query retrieval subsystem; the query retrieval subsystem is connected to the cloud platform to query the instrument's current life data, current operating data, current operating status data, benchmark life data, benchmark operating data and benchmark operating status data, and to track and trace the instrument.

3. The instrument scrapping evaluation method according to claim 2, wherein the query retrieval subsystem has computer query retrieval interface, intelligent terminal query retrieval interface and telephone voice query retrieval interface, which are respectively connected to the cloud platform information through the operation evaluation subsystem.

4. The instrument scrapping evaluation method according to claim 1, wherein the traceability subsystem includes the instrument detection management module, installation and use management module and maintenance/scrap management module, which are respectively connected with the cloud platform information.

5. The instrument scrapping evaluation method according to claim 1, wherein operation evaluation subsystem includes component evaluation module, whole evaluation module, alarm module and query retrieval module; the above modules are respectively connected with the cloud platform information; among them, the component evaluation module is also connected to the overall evaluation module with one-way information; the overall evaluation module is connected with the alarm module information; query retrieval module and query retrieval subsystem information connection.

6. The instrument scrapping evaluation method according to claim 5, wherein the overall evaluation module evaluates the instrument according to the evaluation results of the component evaluation module to determine the operating status of the instrument.

7. The instrument scrapping evaluation method according to claim 1, wherein includes the following steps:
the cloud platform regularly downloads and stores the officially published benchmark life data, benchmark operation data and benchmark operation state data, integrates and analyzes the benchmark operation state data when the instrument is worn or scrapped, and makes real-time corrections;
through the traceability subsystem, the current life data of the instrument is obtained, and the current life data is transferred to the cloud platform for storage;
when the instrument is running, it can track the operation and status of the instrument in real time by running the monitoring subsystem, obtain the current operation data of the instrument, and transfer the current operation data to the cloud platform for storage;
operation evaluation subsystem, which obtains benchmark life data, benchmark operation data and benchmark operation state data from the cloud platform;
the current life data and current operating data are compared and analyzed with the benchmark life data and the benchmark operating data respectively to obtain the current operating status data;
again when the cloud platform for instrument/scrap loss corresponding benchmark running status data, and compared with the current running status data analysis, get the instrument need to repair/scrap or normal operation of the evaluation results, and output the corresponding alarm, operations staff to alert again said to repair/scrap instruments for artificial judgment, And artificial judgment result to feedback to operation evaluation subsystem, get the failure datum running status data, the failure datum life data and the failure datum operation data, the data retransmission to cloud storage platform, through life with artificial judgment before the benchmark data respectively, benchmark data operation and the running state of the benchmark data integration, form the benchmark operation state data, benchmark life data and benchmark operation data for next use.

8. The instrument scrapping evaluation method according to claim 7, wherein the evaluation method also includes inputting the information to be queried in the query retrieval subsystem, and directionally querying the instrument's current life data, current operating data, current operating state data, benchmark life data, benchmark operating data and benchmark operating state data through the operation of the evaluation subsystem.

9. The instrument scrapping evaluation method according to claim 2, wherein the traceability subsystem includes the instrument detection management module, installation and use management module and maintenance/scrap management module, which are respectively connected with the cloud platform information.

10. The instrument scrapping evaluation method according to claim 2, wherein operation evaluation subsystem includes component evaluation module, whole evaluation module, alarm module and query retrieval module; the above modules are respectively connected with the cloud platform information; among them, the component evaluation module is also connected to the overall evaluation module with one-way information; the overall evaluation module is connected with the alarm module information; query retrieval module and query retrieval subsystem information connection.

11. The instrument scrapping evaluation method according to claim 10, wherein the overall evaluation module evaluates the instrument according to the evaluation results of the component evaluation module to determine the operating status of the instrument.

12. The instrument scrapping evaluation method according to claim 3, wherein the traceability subsystem includes the instrument detection management module, installation and use management module and maintenance/scrap management module, which are respectively connected with the cloud platform information.

13. The instrument scrapping evaluation method according to claim 3, wherein operation evaluation subsystem includes component evaluation module, whole evaluation module, alarm module and query retrieval module; the above modules are respectively connected with the cloud platform information; among them, the component evaluation module is also connected to the overall evaluation module with one-way information; the overall evaluation module is connected with the alarm module information; query retrieval module and query retrieval subsystem information connection.

14. The instrument scrapping evaluation method according to claim 13, wherein the overall evaluation module evaluates the instrument according to the evaluation results of the component evaluation module to determine the operating status of the instrument.

15. The instrument scrapping evaluation method according to claim 2, wherein includes the following steps:
the cloud platform regularly downloads and stores the officially published benchmark life data, benchmark operation data and benchmark operation state data, integrates and analyzes the benchmark operation state data when the instrument is worn or scrapped, and makes real-time corrections;
through the traceability subsystem, the current life data of the instrument is obtained, and the current life data is transferred to the cloud platform for storage;
when the instrument is running, it can track the operation and status of the instrument in real time by running the monitoring subsystem, obtain the current operation data of the instrument, and transfer the current operation data to the cloud platform for storage;
operation evaluation subsystem, which obtains benchmark life data, benchmark operation data and benchmark operation state data from the cloud platform;
the current life data and current operating data are compared and analyzed with the benchmark life data and the benchmark operating data respectively to obtain the current operating status data;
again when the cloud platform for instrument/scrap loss corresponding benchmark running status data, and compared with the current running status data analysis, get the instrument need to repair/scrap or normal operation of the evaluation results, and output the corresponding alarm, operations staff to alert again said to repair/scrap instruments for artificial judgment, And artificial judgment result to feedback to operation evaluation subsystem, get the failure datum running status data, the failure datum life data and the failure datum operation data, the data retransmission to cloud storage platform, through life with artificial judgment before the benchmark data respectively, benchmark data operation and the running state of the benchmark data integration, form the benchmark operation state data, benchmark life data and benchmark operation data for next use.

16. The instrument scrapping evaluation method according to claim 15, wherein the evaluation method also includes inputting the information to be queried in the query retrieval subsystem, and directionally querying the instrument's current life data, current operating data, current operating state data, benchmark life data, benchmark operating data and benchmark operating state data through the operation of the evaluation subsystem.

17. The instrument scrapping evaluation method according to claim 3, wherein includes the following steps:
the cloud platform regularly downloads and stores the officially published benchmark life data, benchmark operation data and benchmark operation state data, integrates and analyzes the benchmark operation state data when the instrument is worn or scrapped, and makes real-time corrections;
through the traceability subsystem, the current life data of the instrument is obtained, and the current life data is transferred to the cloud platform for storage;
when the instrument is running, it can track the operation and status of the instrument in real time by running the monitoring subsystem, obtain the current operation data of the instrument, and transfer the current operation data to the cloud platform for storage;
operation evaluation subsystem, which obtains benchmark life data, benchmark operation data and benchmark operation state data from the cloud platform;
the current life data and current operating data are compared and analyzed with the benchmark life data and the benchmark operating data respectively to obtain the current operating status data;
again when the cloud platform for instrument/scrap loss corresponding benchmark running status data, and compared with the current running status data analysis, get the instrument need to repair/scrap or normal operation of the evaluation results, and output the corresponding alarm, operations staff to alert again said to repair/scrap instruments for artificial judgment, And artificial judgment result to feedback to operation evaluation subsystem, get the failure datum running status data, the failure datum life data and the failure datum operation data, the data retransmission to cloud storage platform, through life with artificial judgment before the benchmark data respectively, benchmark data operation and the running state of the benchmark data integration, form the benchmark operation state data, benchmark life data and benchmark operation data for next use.

18. The instrument scrapping evaluation method according to claim 17, wherein the evaluation method also includes inputting the information to be queried in the query retrieval subsystem, and directionally querying the instrument's current life data, current operating data, current operating state data, benchmark life data, benchmark operating data and benchmark operating state data through the operation of the evaluation subsystem.

19. The instrument scrapping evaluation method according to claim 5, wherein includes the following steps:
the cloud platform regularly downloads and stores the officially published benchmark life data, benchmark operation data and benchmark operation state data, integrates and analyzes the benchmark operation state data when the instrument is worn or scrapped, and makes real-time corrections;
through the traceability subsystem, the current life data of the instrument is obtained, and the current life data is transferred to the cloud platform for storage;
when the instrument is running, it can track the operation and status of the instrument in real time by running the monitoring subsystem, obtain the current operation data of the instrument, and transfer the current operation data to the cloud platform for storage;
operation evaluation subsystem, which obtains benchmark life data, benchmark operation data and benchmark operation state data from the cloud platform;
the current life data and current operating data are compared and analyzed with the benchmark life data and the benchmark operating data respectively to obtain the current operating status data;
again when the cloud platform for instrument/scrap loss corresponding benchmark running status data, and compared with the current running status data analysis, get the instrument need to repair/scrap or normal operation of the evaluation results, and output the corresponding alarm, operations staff to alert again said to repair/scrap instruments for artificial judgment, And artificial judgment result to feedback to operation evaluation subsystem, get the failure datum running status data, the failure datum life data and the failure datum operation data, the data retransmission to cloud storage platform, through life with artificial judgment before the benchmark data respectively, benchmark data operation and the running state of the benchmark data integration, form the benchmark operation state data, benchmark life data and benchmark operation data for next use.

20. The instrument scrapping evaluation method according to claim 19, wherein the evaluation method also includes inputting the information to be queried in the query retrieval subsystem, and directionally querying the instrument's current life data, current operating data, current operating state data, benchmark life data, benchmark operating data and benchmark operating state data through the operation of the evaluation subsystem.
